(19) United States
(12) Patent Application Publication
(10) Pub. No.: US 2026/0003979 A1
(43) Pub. Date: Jan. 1, 2026

(54) APPLICATION CONTROL FRAMEWORK

(71) Applicant: Snowflake Inc., Bozeman, MT (US)

(72) Inventor: Marcus A. Henderson, San Marcos, CA (US)

(21) Appl. No.: 18/759,285

(22) Filed: Jun. 28, 2024

(51) Int. Cl. G06F 21/60; G06F 8/61

(52) U.S. Cl. CPC G06F 21/604; G06F 8/61; G06F 2221/2141

(57) ABSTRACT

Disclosed are techniques for using an application control framework to build, share and manage access to and usage of applications via a data sharing platform. An application control framework may provide a number of predefined controls and may receive values for certain predefined controls as well as custom control definitions and corresponding values from a provider. The application control framework may also receive application logic and may build an application package comprising the application logic and a set of controls including the predefined and custom controls to manage access to and usage of the application. In response to a consumer of the data sharing platform importing the application package, the application control framework may call the set of install scripts to install an instance of the application in the consumer account using the application logic and manage access to the application instance by the consumer using the set of controls.

### TECHNICAL FIELD

The present disclosure relates to sharing applications via data sharing platforms, and particularly to providing a framework for controlling and customizing the sharing of applications via data sharing platforms.

### BACKGROUND

Databases are widely used for data storage and access in computing applications. Databases may include one or more tables that include or reference data that can be read, modified, or deleted using queries. Databases may be used for storing and/or accessing personal information or other sensitive information. Secure storage and access of database data may be provided by encrypting and/or storing data in an encrypted form to prevent unauthorized access. In some cases, data sharing may be desirable to let other parties perform queries against a set of data.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram depicting an example computing environment in which the methods disclosed herein may be implemented, in accordance with some embodiments of the present invention.

FIG. 1B is a block diagram illustrating an example virtual warehouse, in accordance with some embodiments of the present invention.

FIG. 2 is a schematic block diagram of data that may be used to implement a public or private data exchange, in accordance with some embodiments of the present invention.

FIG. 3 is a schematic block diagram of deployment of a data exchange that illustrates consumer and provider managed data access techniques, in accordance with some embodiments of the present invention.

FIG. 4A is a block diagram of a deployment of a data exchange, illustrating application sharing techniques, in accordance with some embodiments of the present invention.

FIG. 4B is a diagram illustrating example controls for restricting/limiting functionality of an application shared via a data sharing platform, in accordance with some embodiments of the present invention.

FIG. 4C is a diagram illustrating example control definitions, in accordance with some embodiments of the present invention.

FIG. 4D is a diagram illustrating an example template for custom control definitions, in accordance with some embodiments of the present invention.

FIGS. 5A-5C are block diagrams illustrating building, installation/sharing, and

management of an application using an application control framework, in accordance with some embodiments of the present invention.

FIG. 5D is a diagram illustrating event messages, in accordance with some embodiments of the present invention.

FIG. 5E is a diagram illustrating an events summary view indicating all events from an event master table generated by the application control framework of FIGS. 4A, 5A and 5B, in accordance with some embodiments of the present invention.

FIG. 6 is a flow diagram of a method for using an application control framework to build, install/share, and manage an application, in accordance with some embodiments of the present invention.

FIG. 7 is a block diagram of an example computing device that may perform one or more of the operations described herein, in accordance with some embodiments of the present invention.

### DETAILED DESCRIPTION

Data providers often have data assets that are cumbersome to share. A data asset may be data that is of interest to another entity. For example, a large online retail company may have a data set that includes the purchasing habits of millions of consumers over the last ten years. This data set may be large. If the online retailer wishes to share all or a portion of this data with another entity, the online retailer may need to use old and slow methods to transfer the data, such as a file-transfer-protocol (FTP), or even copying the data onto physical media and mailing the physical media to the other entity. This has several disadvantages. First, it is slow as copying terabytes or petabytes of data can take days. Second, once the data is delivered, the provider cannot control what happens to the data. The recipient can alter the data, make copies, or share it with other parties. Third, the only entities that would be interested in accessing such a large data set in such a manner are large corporations that can afford the complex logistics of transferring and processing the data as well as the high price of such a cumbersome data transfer. Thus, smaller entities (e.g., “mom and pop” shops) or even smaller, more nimble cloud-focused startups are often priced out of accessing this data, even though the data may be valuable to their businesses. This may be because raw data assets are generally too unpolished and full of potentially sensitive data to simply outright sell/provide to other companies. Data cleaning, de-identification, aggregation, joining, and other forms of data enrichment need to be performed by the owner of data before it is shareable with another party. This is time-consuming and expensive. Finally, it is difficult to share data assets with many entities because traditional data sharing methods do not allow scalable sharing for the reasons mentioned above. Traditional sharing methods also introduce latency and delays in terms of all parties having access to the most recently-updated data.

Private and public data exchanges may allow data providers to more easily and securely share their data assets with other entities. A public data exchange (also referred to herein as a “Snowflake data marketplace,” or a “data marketplace”) may provide a centralized repository with open access where a data provider may publish and control live and read-only data sets to thousands of consumers. A private data exchange (also referred to herein as a “data exchange”) may be under the data provider's brand, and the data provider may control who can gain access to it. The data exchange may be for internal use only, or may also be opened to consumers, partners, suppliers, or others. The data provider may control what data assets are listed as well as control who has access to which sets of data. This allows for a seamless way to discover and share data both within a data provider's organization and with its business partners.

The data exchange may be facilitated by a cloud computing service such as the SNOWFLAKE™ cloud computing service, and allows data providers to offer data assets directly from their own online domain (e.g., website) in a private online marketplace with their own branding. The data exchange may provide a centralized, managed hub for an entity to list internally or externally-shared data assets, inspire data collaboration, and also to maintain data governance and to audit access. With the data exchange, data providers may be able to share data without copying it between companies. Data providers may invite other entities to view their data listings, control which data listings appear in their private online marketplace, control who can access data listings and how others can interact with the data assets connected to the listings. This may be thought of as a “walled garden” marketplace, in which visitors to the garden must be approved and access to certain listings may be limited.

As an example, Company A may be a consumer data company that has collected and analyzed the consumption habits of millions of individuals in several different categories. Their data sets may include data in the following categories: online shopping, video streaming, electricity consumption, automobile usage, internet usage, clothing purchases, mobile application purchases, club memberships, and online subscription services. Company A may desire to offer these data sets (or subsets or derived products of these data sets) to other entities. For example, a new clothing brand may wish to access data sets related to consumer clothing purchases and online shopping habits. Company A may support a page on its website that is or functions substantially similar to a data exchange, where a data consumer (e.g., the new clothing brand) may browse, explore, discover, access and potentially purchase data sets directly from Company A. Further, Company A may control: who can enter the data exchange, the entities that may view a particular listing, the actions that an entity may take with respect to a listing (e.g., view only), and any other suitable action. In addition, a data provider may combine its own data with other data sets from, e.g., a public data exchange (also referred to as a “data marketplace”), and create new listings using the combined data.

A data exchange may be an appropriate place to discover, assemble, clean, and enrich data to make it more monetizable. A large company on a data exchange may assemble data from across its divisions and departments, which could become valuable to another company. In addition, participants in a private ecosystem data exchange may work together to join their datasets together to jointly create a useful data product that any one of them alone would not be able to produce. Once these joined datasets are created, they may be listed on the data exchange or on the data marketplace.

Sharing data may be performed when a data provider creates a share object (hereinafter referred to as a share) of a database in the data provider's account and grants the share access to particular objects (e.g., tables, secure views, and secure user-defined functions (UDFs)) of the database. Then, a read-only database may be created using information provided in the share. Access to this database may be controlled by the data provider. A “share” encapsulates all of the information required to share data in a database. A share may include at least three pieces of information: (1) privileges that grant access to the database(s) and the schema containing the objects to share, (2) the privileges that grant access to the specific objects (e.g., tables, secure views, and secure UDFs), and (3) the consumer accounts with which the database and its objects are shared. The consumer accounts with which the database and its objects are shared may be indicated by a list of references to those consumer accounts contained within the share object. Only those consumer accounts that are specifically listed in the share object may be allowed to look up, access, and/or import from this share object. By modifying the list of references of other consumer accounts, the share object can be made accessible to more accounts or be restricted to fewer accounts.

In some embodiments, each share object contains a single role. Grants between this role and objects define what objects are being shared and with what privileges these objects are shared. The role and grants may be similar to any other role and grant system in the implementation of role-based access control. By modifying the set of grants attached to the role in a share object, more objects may be shared (by adding grants to the role), fewer objects may be shared (by revoking grants from the role), or objects may be shared with different privileges (by changing the type of grant, for example to allow write access to a shared table object that was previously read-only). In some embodiments, share objects in a provider account may be imported into the target consumer account using alias objects and cross-account role grants.

When data is shared, no data is copied or transferred between users. Sharing is accomplished through the cloud computing services of a cloud computing service provider such as SNOWFLAKE™. Shared data may then be used to process SQL queries, possibly including joins, aggregations, or other analysis. In some instances, a data provider may define a share such that “secure joins” are permitted to be performed with respect to the shared data. A secure join may be performed such that analysis may be performed with respect to shared data but the actual shared data is not accessible by the data consumer (e.g., recipient of the share).

A data exchange may also implement role-based access control to govern access to objects within consumer accounts using account level roles and grants. In one embodiment, account level roles are special objects in a consumer account that are assigned to users. Grants between these account level roles and database objects define what privileges the account level role has on these objects. For example, a role that has a usage grant on a database can “see” this database when executing the command “show databases”; a role that has a select grant on a table can read from this table but not write to the table. The role would need to have a modify grant on the table to be able to write to it.

Because consumers of data often require the ability to perform various functions on data that has been shared with them, a data exchange may enable users of a data marketplace to build native applications that can be shared with other users of the data marketplace. The native applications can be published and discovered in the data marketplace like any other data listing, and consumers can install them in their local data marketplace account to serve their data processing needs. This helps to bring data processing services and capabilities to consumers instead of requiring a consumer to share data with e.g., a service provider who can perform these data processing services and share the processed data back to the consumer. Stated differently, instead of a consumer having to share potentially sensitive data with a third party who can perform the necessary data processing services and send the results back to the consumer, the desired data processing functionality may be encapsulated, and then shared with the consumer so that the consumer does not have to share their potentially sensitive data.

Providers who share native applications require the ability to understand consumer usage of the application, control the application functionality each consumer of their native application has access to, and the ability to disable usage for any given reason. Monitoring native applications running in consumer accounts is also important for providers. Event sharing between native application providers and consumers is crucial for observability, troubleshooting, and transparent data governance. Providers want to support their applications running in consumer accounts by having access to events generated by their applications. Events may include for example errors and warnings, metrics, usage logs, debug logs, and query audit logs. These events can help a provider understand how consumers use their shared applications.

However, current native application sharing mechanisms suffer from a lack of adequate controls. More specifically, providers lack controls to restrict stored procedure/function usage, apply limits on stored procedure/function execution and record processing, and apply restrictions on event sharing, among other functionality.

Embodiments of the present disclosure address the above and other issues by providing techniques for using an application control framework to build, share and manage access to and usage of applications via a data sharing platform. An application control framework may provide a number of predefined controls and may receive values for certain predefined controls as well as custom control definitions and values from a provider. The application control framework may also receive application logic corresponding to an application to be shared by the provider. The application control framework may build an application package comprising the application logic, an install script to install the application and a set of controls including the predefined and custom controls to manage access to and usage of the application. In response to a consumer of the data sharing platform importing the application package, the application control framework may call the set of install scripts to install an instance of the application in the consumer account using the application logic and manage access to the application instance by the consumer using the set of controls.

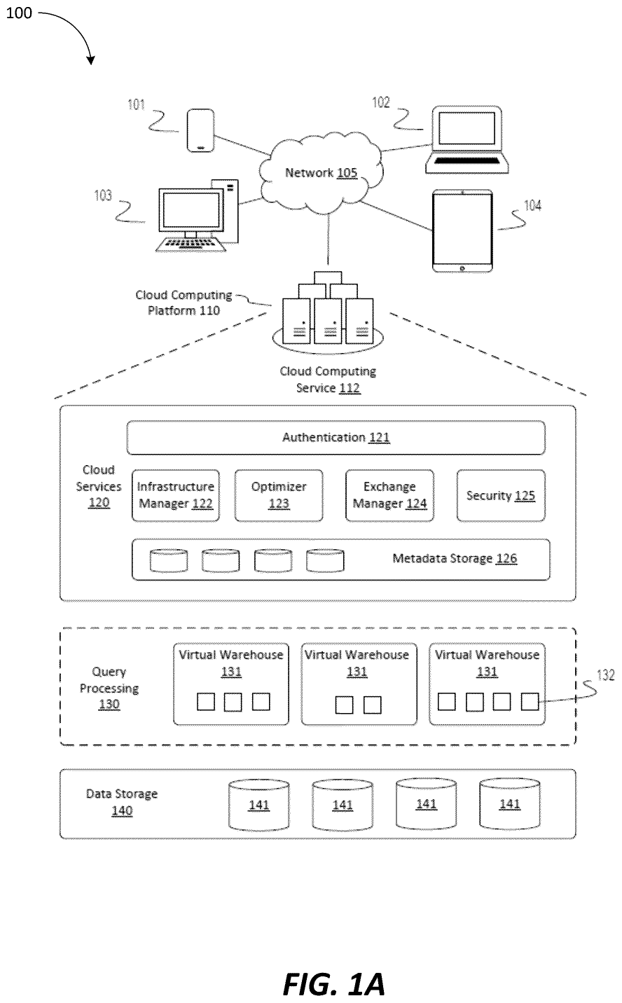

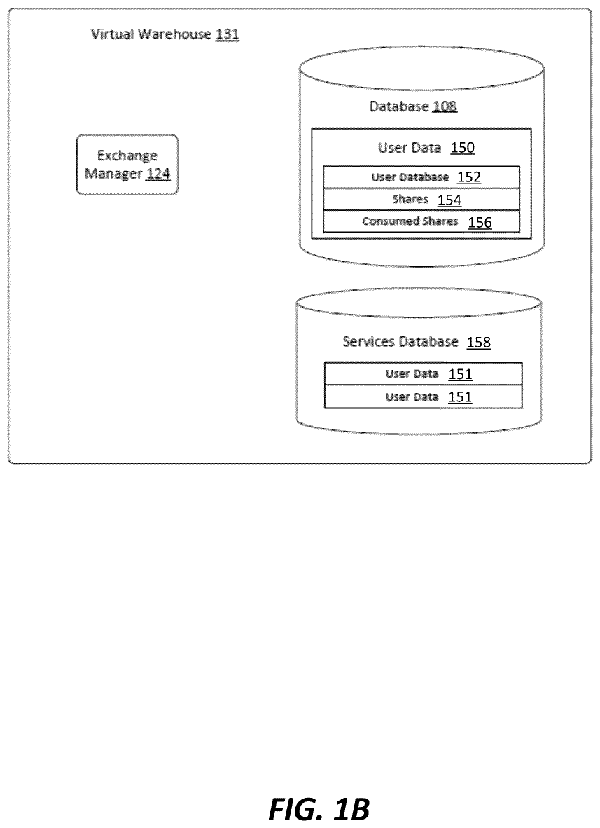

FIG. 1A is a block diagram of an example computing environment 100 in which the systems and methods disclosed herein may be implemented. A cloud computing platform 110 may be implemented, such as Amazon Web Services™ (AWS), Microsoft Azure™, Google Cloud™, or the like. As known in the art, a cloud computing platform 110 provides computing resources and storage resources that may be acquired (purchased) or leased and configured to execute applications and store data.

The cloud computing platform 110 may host a cloud computing service 112 that facilitates storage of data on the cloud computing platform 110 (e.g. data management and access) and analysis functions (e.g. SQL queries, analysis), as well as other computation capabilities (e.g., secure data sharing between users of the cloud computing platform 110). The cloud computing platform 110 may include a three-tier architecture: data storage 140, query processing 130, and cloud services 120.

Data storage 140 may facilitate the storing of data on the cloud computing platform 110 in one or more cloud databases 141. Data storage 140 may use a storage service such as Amazon S3™ to store data and query results on the cloud computing platform 110. In particular embodiments, to load data into the cloud computing platform 110, data tables may be horizontally partitioned into large, immutable files which may be analogous to blocks or pages in a traditional database system. Within each file, the values of each attribute or column are grouped together and compressed using a scheme sometimes referred to as hybrid columnar. Each table has a header which, among other metadata, contains the offsets of each column within the file.

In addition to storing table data, data storage 140 facilitates the storage of temp data generated by query operations (e.g., joins), as well as the data contained in large query results. This may allow the system to compute large queries without out-of-memory or out-of-disk errors. Storing query results this way may simplify query processing as it removes the need for server-side cursors found in traditional database systems.

Query processing 130 may handle query execution within elastic clusters of virtual machines, referred to herein as virtual warehouses or data warehouses. Thus, query processing 130 may include one or more virtual warehouses 131, which may also be referred to herein as data warehouses. The virtual warehouses 131 may be one or more virtual machines operating on the cloud computing platform 110. The virtual warehouses 131 may be compute resources that may be created, destroyed, or resized at any point, on demand. This functionality may create an “elastic” virtual warehouse that expands, contracts, or shuts down according to the user's needs. Expanding a virtual warehouse involves generating one or more compute nodes 132 to a virtual warehouse 131. Contracting a virtual warehouse involves removing one or more compute nodes 132 from a virtual warehouse 131. More compute nodes 132 may lead to faster compute times. For example, a data load which takes fifteen hours on a system with four nodes might take only two hours with thirty-two nodes.

Cloud services 120 may be a collection of services that coordinate activities across the cloud computing service 112. These services tie together all of the different components of the cloud computing service 112 in order to process user requests, from login to query dispatch. Cloud services 120 may operate on compute instances provisioned by the cloud computing service 112 from the cloud computing platform 110. Cloud services 120 may include a collection of services that manage virtual warehouses, queries, transactions, data exchanges, and the metadata associated with such services, such as database schemas, access control information, encryption keys, and usage statistics. Cloud services 120 may include, but not be limited to, authentication engine 121, infrastructure manager 122, optimizer 123, exchange manager 124, security engine 125, and metadata storage 126.

FIG. 1B is a block diagram illustrating an example virtual warehouse 131. The exchange manager 124 may facilitate the sharing of data between data providers and data consumers, using, for example, a data exchange. For example, cloud computing service 112 may manage the storage and access of a database 108. The database 108 may include various instances of user data 150 for different users e.g., different enterprises or individuals. The user data 150 may include a user database 152 of data stored and accessed by that user. The user database 152 may be subject to access controls such that only the owner of the data is allowed to change and access the user database 152 upon authenticating with the cloud computing service 112. For example, data may be encrypted such that it can only be decrypted using decryption information possessed by the owner of the data. Using the exchange manager 124, specific data from a user database 152 that is subject to these access controls may be shared with other users in a controlled manner. In particular, a user may specify shares 154 that may be shared in a public or data exchange in an uncontrolled manner or shared with specific other users in a controlled manner as described above. A “share” encapsulates all of the information required to share data in a database. A share may include at least three pieces of information: (1) privileges that grant access to the database(s) and the schema containing the objects to share, (2) the privileges that grant access to the specific objects (e.g., tables, secure views, and secure UDFs), and (3) the consumer accounts with which the database and its objects are shared. When data is shared, no data is copied or transferred between users. Sharing is accomplished through the cloud services 120 of cloud computing service 112.

Sharing data may be performed when a data provider creates a share of a database in the data provider's account and grants access to particular objects (e.g., tables, secure views, and secure user-defined functions (UDFs)). Then a read-only database may be created using information provided in the share. Access to this database may be controlled by the data provider.

Shared data may then be used to process SQL queries, possibly including joins, aggregations, or other analysis. In some instances, a data provider may define a share such that “secure joins” are permitted to be performed with respect to the shared data. A secure join may be performed such that analysis may be performed with respect to shared data but the actual shared data is not accessible by the data consumer (e.g., recipient of the share). A secure join may be performed as described in U.S. application Ser. No. 16/368,339, filed Mar. 18, 2019.

User devices 101-104, such as laptop computers, desktop computers, mobile phones, tablet computers, cloud-hosted computers, cloud-hosted serverless processes, or other computing processes or devices may be used to access the virtual warehouse 131 or cloud service 120 by way of a network 105, such as the Internet or a private network.

In the description below, actions are ascribed to users, particularly consumers and providers. Such actions shall be understood to be performed with respect to devices 101-104 operated by such users. For example, notification to a user may be understood to be a notification transmitted to devices 101-104, an input or instruction from a user may be understood to be received by way of the user's devices 101-104, and interaction with an interface by a user shall be understood to be interaction with the interface on the user's devices 101-104. In addition, database operations (joining, aggregating, analysis, etc.) ascribed to a user (consumer or provider) shall be understood to include performing of such actions by the cloud computing service 112 in response to an instruction from that user.

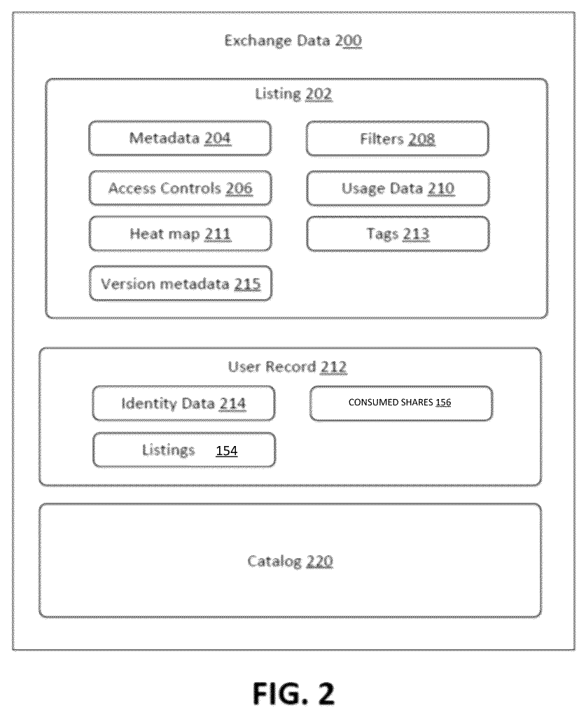

FIG. 2 is a schematic block diagram of data that may be used to implement a public or data exchange in accordance with an embodiment of the present invention. The exchange manager 124 may operate with respect to some or all of the illustrated exchange data 200, which may be stored on the platform executing the exchange manager 124 (e.g., the cloud computing platform 110) or at some other location. The exchange data 200 may include a plurality of listings 202 describing data that is shared by a first user (“the provider”). The listings 202 may be listings in a data exchange or in a data marketplace. The access controls, management, and governance of the listings may be similar for both a data marketplace and a data exchange.

The listing 202 may include access controls 206, which may be configurable to any suitable access configuration. For example, access controls 206 may indicate that the shared data is available to any member of the private exchange without restriction (an “any share” as used elsewhere herein). The access controls 206 may specify a class of users (members of a particular group or organization) that are allowed to access the data and/or see the listing. The access controls 206 may specify that a “point-to-point” share in which users may request access but are only allowed access upon approval of the provider. The access controls 206 may specify a set of user identifiers of users that are excluded from being able to access the data referenced by the listing 202.

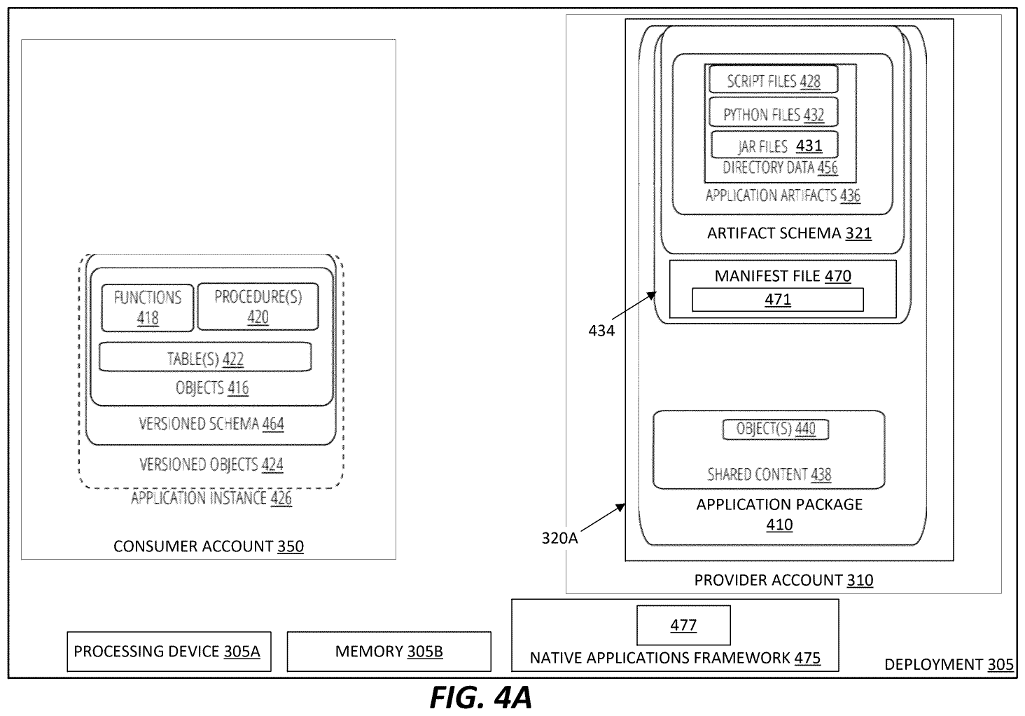

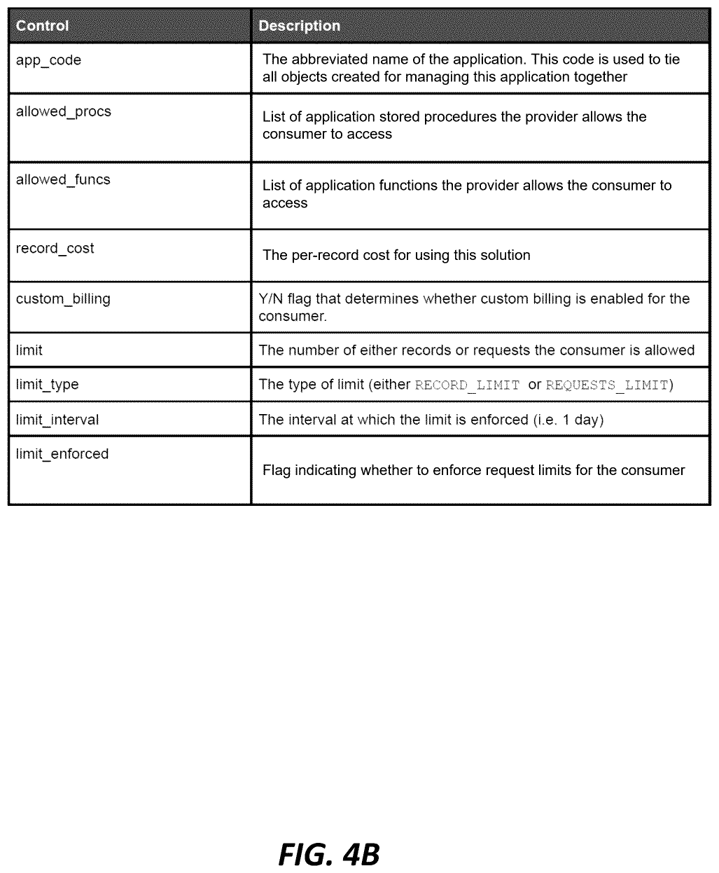

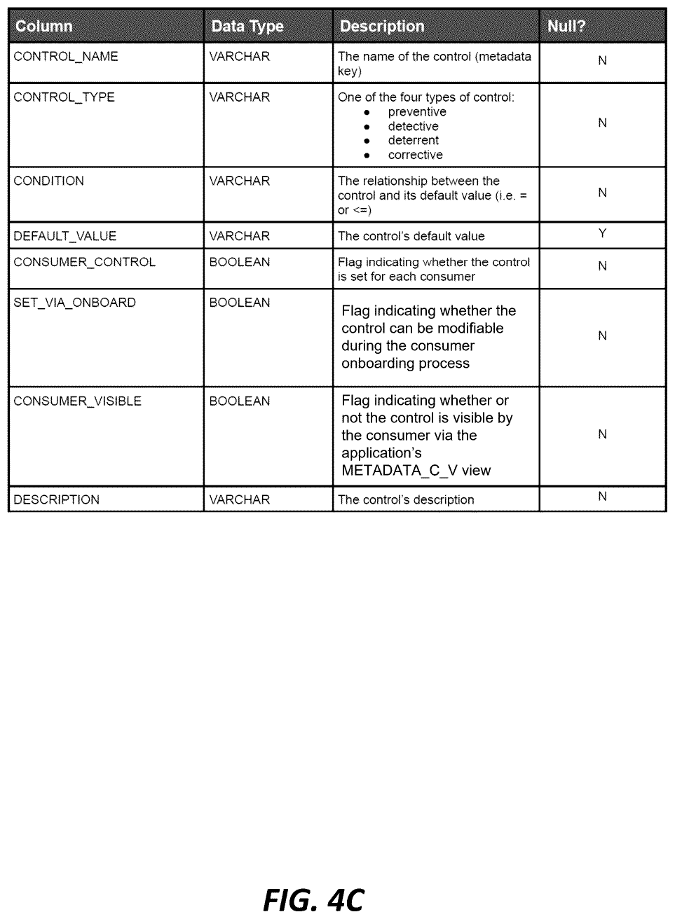

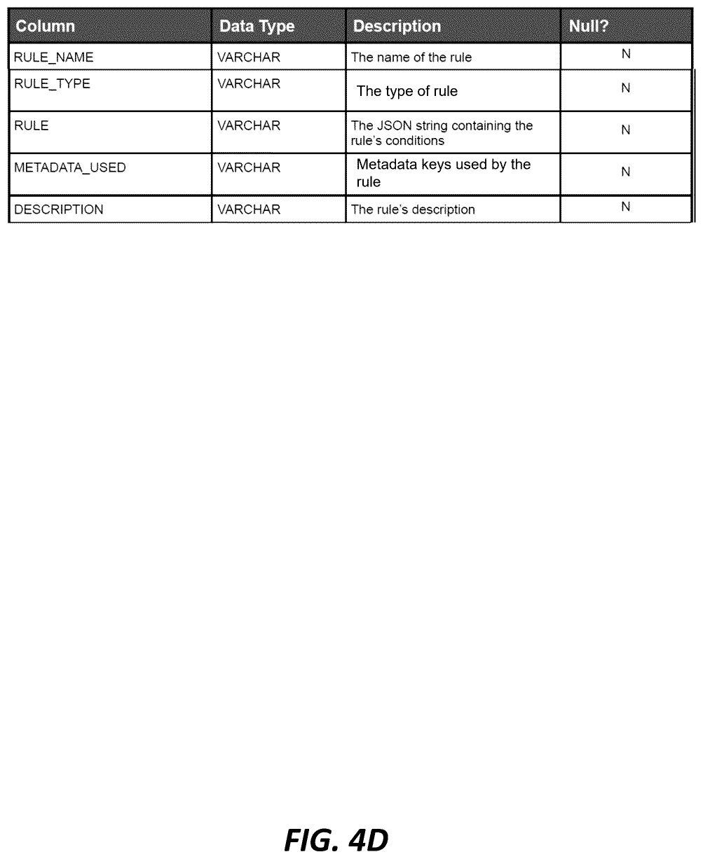

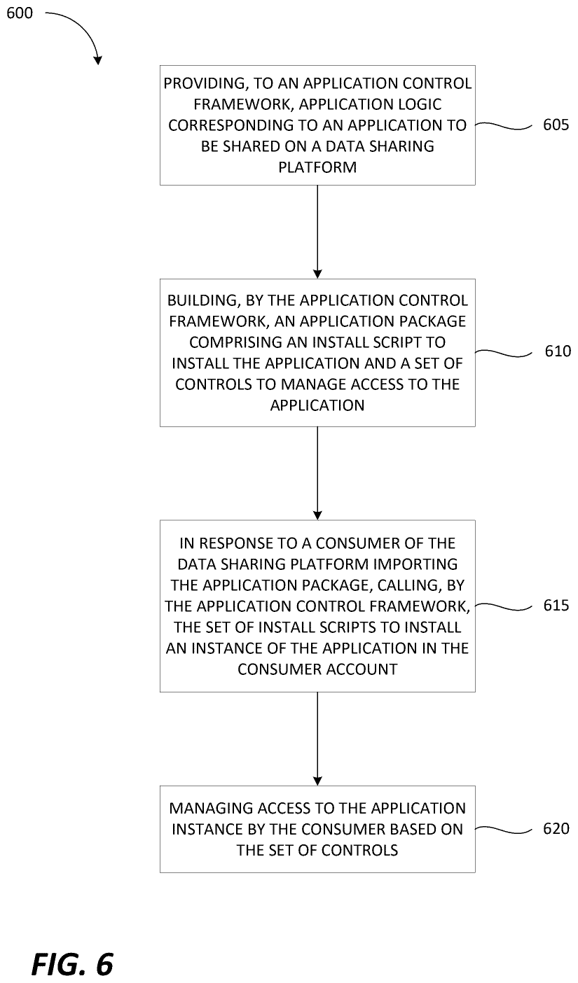

Note that some listings 202 may be discoverable by users without further authentication or access permissions whereas actual accesses are only permitted after a subsequent authentication step (see discussion of FIGS. 4 and 6). The access controls 206 may specify that a listing 202 is only discoverable by specific users or classes of users.

Note also that a default function for listings 202 is that the data referenced by the share is not exportable by the consumer. Alternatively, the access controls 206 may specify that this is not permitted. For example, access controls 206 may specify that secure operations (secure joins and secure functions as discussed below) may be performed with respect to the shared data such that viewing and exporting of the shared data is not permitted.

In some embodiments, once a user is authenticated with respect to a listing 202, a reference to that user (e.g., user identifier of the user's account with the virtual warehouse 131) is added to the access controls 206 such that the user will subsequently be able to access the data referenced by the listing 202 without further authentication.

The listing 202 may define one or more filters 208. For example, the filters 208 may define specific identity data 214 (also referred to herein as user identifiers) of users that may view references to the listing 202 when browsing the catalog 220. The filters 208 may define a class of users (users of a certain profession, users associated with a particular company or organization, users within a particular geographical area or country) that may view references to the listing 202 when browsing the catalog 220. In this manner, a private exchange may be implemented by the exchange manager 124 using the same components. In some embodiments, an excluded user that is excluded from accessing a listing 202 i.e., adding the listing 202 to the consumed shares 156 of the excluded user, may still be permitted to view a representation of the listing when browsing the catalog 220 and may further be permitted to request access to the listing 202 as discussed below. Requests to access a listing by such excluded users and other users may be listed in an interface presented to the provider of the listing 202. The provider of the listing 202 may then view demand for access to the listing and choose to expand the filters 208 to permit access to excluded users or classes of excluded users (e.g., users in excluded geographic regions or countries).

Filters 208 may further define what data may be viewed by a user. In particular, filters 208 may indicate that a user that selects a listing 202 to add to the consumed shares 156 of the user is permitted to access the data referenced by the listing but only a filtered version that only includes data associated with the identity data 214 of that user, associated with that user's organization, or specific to some other classification of the user. In some embodiments, a private exchange is by invitation: users invited by a provider to view listings 202 of a private exchange are enabled to do by the exchange manager 124 upon communicating acceptance of an invitation received from the provider.

In some embodiments, a listing 202 may be addressed to a single user. Accordingly, a reference to the listing 202 may be added to a set of “pending shares” that is viewable by the user. The listing 202 may then be added to a group of shares of the user upon the user communicating approval to the exchange manager 124.

The listing 202 may further include usage data 210. For example, the cloud computing service 112 may implement a credit system in which credits are purchased by a user and are consumed each time a user runs a query, stores data, or uses other services implemented by the cloud computing service 112. Accordingly, usage data 210 may record an amount of credits consumed by accessing the shared data. Usage data 210 may include other data such as a number of queries, a number of aggregations of each type of a plurality of types performed against the shared data, or other usage statistics. In some embodiments, usage data for a listing 202 or multiple listings 202 of a user is provided to the user in the form of a shared database, i.e. a reference to a database including the usage data is added by the exchange manager 124 to the consumed shares 156 of the user.

The listing 202 may also include a heat map 211, which may represent the geographical locations in which users have clicked on that particular listing. The cloud computing service 112 may use the heat map to make replication decisions or other decisions with the listing. For example, a data exchange may display a listing that contains weather data for Georgia, USA. The heat map 211 may indicate that many users in California are selecting the listing to learn more about the weather in Georgia. In view of this information, the cloud computing service 112 may replicate the listing and make it available in a database whose servers are physically located in the western United States, so that consumers in California may have access to the data. In some embodiments, an entity may store its data on servers located in the western United States. A particular listing may be very popular to consumers. The cloud computing service 112 may replicate that data and store it in servers located in the eastern United States, so that consumers in the Midwest and on the East Coast may also have access to that data.

The listing 202 may also include one or more tags 213. The tags 213 may facilitate simpler sharing of data contained in one or more listings. As an example, a large company may have a human resources (HR) listing containing HR data for its internal employees on a data exchange. The HR data may contain ten types of HR data (e.g., employee number, selected health insurance, current retirement plan, job title, etc.). The HR listing may be accessible to 100 people in the company (e.g., everyone in the HR department). Management of the HR department may wish to add an eleventh type of HR data (e.g., an employee stock option plan). Instead of manually adding this to the HR listing and granting each of the 100 people access to this new data, management may simply apply an HR tag to the new data set and that can be used to categorize the data as HR data, list it along with the HR listing, and grant access to the 100 people to view the new data set.

The listing 202 may also include version metadata 215. Version metadata 215 may provide a way to track how the datasets are changed. This may assist in ensuring that the data that is being viewed by one entity is not changed prematurely. For example, if a company has an original data set and then releases an updated version of that data set, the updates could interfere with another user's processing of that data set, because the update could have different formatting, new columns, and other changes that may be incompatible with the current processing mechanism of the recipient user. To remedy this, the cloud computing service 112 may track version updates using version metadata 215. The cloud computing service 112 may ensure that each data consumer accesses the same version of the data until they accept an updated version that will not interfere with current processing of the data set.

The exchange data 200 may further include user records 212. The user record 212 may include data identifying the user associated with the user record 212, e.g. an identifier (e.g., warehouse identifier) of a user having user data 151 in service database 158 and managed by the virtual warehouse 131.

The user record 212 may list shares associated with the user, e.g., listings 154 (shares 154) created by the user. The user record 212 may list shares consumed by the user i.e., consumed shares 156 which may be listings 202 created by another user and that have been associated to the account of the user according to the methods described herein. For example, a listing 202 may have an identifier that will be used to reference it in the shares or consumed shares 156 of a user record 212.

The listing 202 may also include metadata 204 describing the shared data. The metadata 204 may include some or all of the following information: an identifier of the provider of the shared data, a URL associated with the provider, a name of the share, a name of tables, a category to which the shared data belongs, an update frequency of the shared data, a catalog of the tables, a number of columns and a number of rows in each table, as well as name for the columns. The metadata 204 may also include examples to aid a user in using the data. Such examples may include sample tables that include a sample of rows and columns of an example table, example queries that may be run against the tables, example views of an example table, example visualizations (e.g., graphs, dashboards) based on a table's data. Other information included in the metadata 204 may be metadata for use by business intelligence tools, text description of data contained in the table, keywords associated with the table to facilitate searching, a link (e.g., URL) to documentation related to the shared data, and a refresh interval indicating how frequently the shared data is updated along with the date the data was last updated.

The metadata 204 may further include category information indicating a type of the data/service (e.g., location, weather), industry information indicating who uses the data/service (e.g., retail, life sciences), and use case information that indicates how the data/service is used (e.g., supply chain optimization, or risk analysis). For instance, retail consumers may use weather data for supply chain optimization. A use case may refer to a problem that a consumer is solving (i.e., an objective of the consumer) such as supply chain optimization. A use case may be specific to a particular industry, or can apply to multiple industries. Any given data listing (i.e., dataset) can help solve one or more use cases, and hence may be applicable to multiple use cases.

The exchange data 200 may further include a catalog 220. The catalog 220 may include a listing of all available listings 202 and may include an index of data from the metadata 204 to facilitate browsing and searching according to the methods described herein. In some embodiments, listings 202 are stored in the catalog in the form of JavaScript Object Notation (JSON) objects.

Note that where there are multiple instances of the virtual warehouse 131 on different cloud computing platforms, the catalog 220 of one instance of the virtual warehouse 131 may store listings or references to listings from other instances on one or more other cloud computing platforms 110. Accordingly, each listing 202 may be globally unique (e.g., be assigned a globally unique identifier across all of the instances of the virtual warehouse 131). For example, the instances of the virtual warehouses 131 may synchronize their copies of the catalog 220 such that each copy indicates the listings 202 available from all instances of the virtual warehouse 131. In some instances, a provider of a listing 202 may specify that it is to be available on only specified one or more computing platforms 110.

In some embodiments, the catalog 220 is made available on the Internet such that it is searchable by a search engine such as the Bing™ search engine or the Google search engine. The catalog may be subject to a search engine optimization (SEO) algorithm to promote its visibility. Potential consumers may therefore browse the catalog 220 from any web browser. The exchange manager 124 may expose uniform resource locators (URLs) linked to each listing 202. This URL may be searchable and can be shared outside of any interface implemented by the exchange manager 124. For example, the provider of a listing 202 may publish the URLs for its listings 202 in order to promote usage of its listing 202 and its brand.

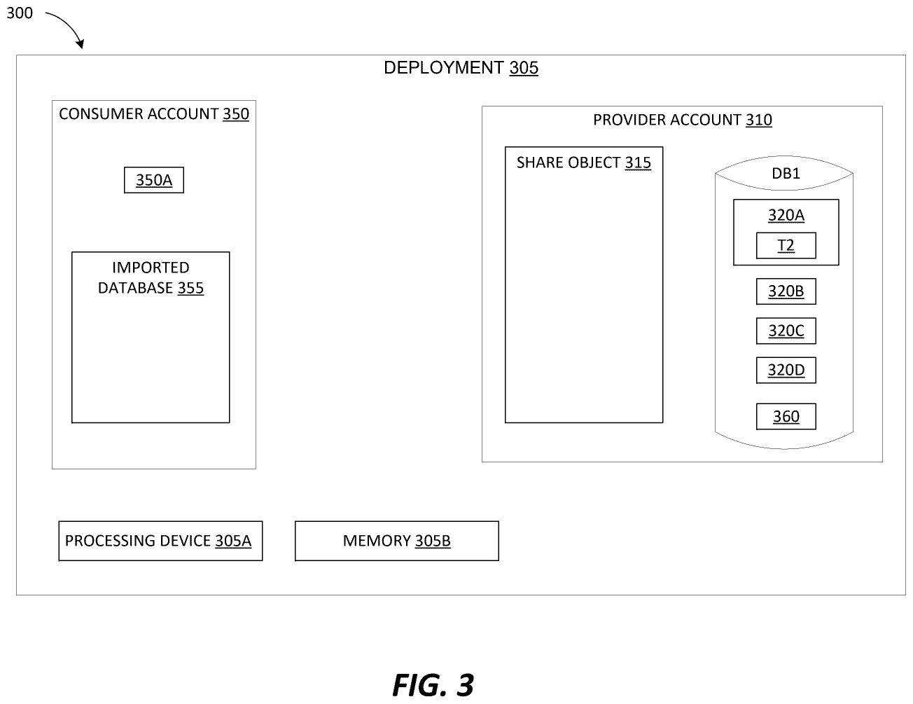

FIG. 3 illustrates a cloud environment 300 comprising a cloud deployment 305, which may comprise a similar architecture to cloud computing service 112 (illustrated in FIG. 1A) and may be a deployment of a data exchange or data marketplace. Although illustrated with a single cloud deployment, the cloud environment 300 may have multiple cloud deployments which may be physically located in separate remote geographical regions but may all be deployments of a single data exchange or data marketplace. Although embodiments of the present disclosure are described with respect to a data exchange, this is for example purpose only and the embodiments of the present disclosure may be implemented in any appropriate enterprise database system or data sharing platform where data may be shared among users of the system/platform.

The cloud deployment 305 may include hardware such as processing device 305A (e.g., processors, central processing units (CPUs), memory 305B (e.g., random access memory (RAM), storage devices (e.g., hard-disk drive (HDD), solid-state drive (SSD), etc.), and other hardware devices (e.g., sound card, video card, etc.). A storage device may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The cloud deployment 305 may comprise any suitable type of computing device or machine that has a programmable processor including, for example, server computers, desktop computers, laptop computers, tablet computers, smartphones, set-top boxes, etc. In some examples, the cloud deployment 305 may comprise a single machine or may include multiple interconnected machines (e.g., multiple servers configured in a cluster).

Databases and schemas may be used to organize data stored in the cloud deployment 305 and each database may belong to a single account within the cloud deployment 305. Each database may be thought of as a container having a classic folder hierarchy within it. Each database may be a logical grouping of schemas and a schema may be a logical grouping of database objects (tables, views, etc.). Each schema may belong to a single database. Together, a database and a schema may comprise a namespace. When performing any operations on objects within a database, the namespace is inferred from the current database and the schema that is in use for the session. If a database and schema are not in use for the session, the namespace must be explicitly specified when performing any operations on the objects. As shown in FIG. 3, the cloud deployment 305 may include a provider account 310 including database DB1 having schemas 320A-320D.

FIG. 3 also illustrates share-based access to objects in the provider account 310. The provider account 310 may create a share object 315, which includes grants to database DB1 and schema 320A, as well as a grant to a table T2 located in schema 320A. The grants on database DB1 and schema 320A may be usage grants and the grant on table T2 may be a select grant. In this case, the table T2 in schema 320A in database DB1 would be shared read-only. The share object 315 may contain a list of references (not shown) to various consumer accounts, including the consumer account 350.

After the share object 315 is created, it may be imported or referenced by consumer account 350 (which has been listed in the share object 315). Consumer account 350 may run a command to list all available share objects for importing. Only if the share object 315 was created with a reference to the consumer account 350, then the consumer account 350 reveals the share object using the command to list all share objects and subsequently import it. In one embodiment, references to a share object in another account are always qualified by account name. For example, consumer account 350 would reference a share object SH1 in provider account A1 with the example qualified name “A1.SH1.” Upon the share object 315 being imported to consumer account 350 (shown as imported database 355), an administrator role (e.g., an account level role) of the consumer account 350 may be given a usage grant to the imported database 355. In this way, a user in account 350 with the administrator role 350A may access data from DB1 that is explicitly shared/included in the share object 315.

Similar to the way that data can be shared from a provider account to a consumer account, applications can also be shared from a provider account to a consumer account. As with sharing of data, sharing of a native application (hereinafter referred to as an application) may be performed using a shared container.

FIG. 4A illustrates an example native application sharing process taking place within the deployment 305. It should be noted that embodiments of the present disclosure may be used with any native application sharing process and the process illustrated in FIG. 4A is not limiting. Upon creating the database DB1 and the schema 320A, the provider account 310 may generate an application package 410 and store it in the schema 320A. The provider account 310 may define the application package 410 with the necessary functionality to install an application 426 (including any objects and procedures required by the application 426) in the consumer account 350. The native applications framework 475 may enable the provider account 310 to indicate that the application package 410 will automatically be invoked with no arguments when a consumer with whom the application package 410 has been shared requests installation of the application. The provider account 310 may create an application share object (not shown) and attach the application package 410 to the application share object. The provider account 310 may then grant the necessary privileges to the application share object including usage on the database DB1, usage on the schema 320A, and usage on the application package 410.

When the consumer account 350 runs a command to see the available listings, they may see a listing corresponding to the application share object and may run a command to create an instance of application 426 from the listing (e.g., CREATE APPLICATION <name> FROM LISTING <listing name>). In response to execution of the command, the native applications framework 475 may automatically trigger execution of script files 428 of the application package 410, which may create objects (e.g., credentials, API integration, and a warehouse) as well as tasks/procedures corresponding to the functionality of the application 426 in the consumer account 350 as discussed in further detail herein. The consumer account 350 may also grant privileges necessary for the instance of application 426 to run (some privileges are granted on objects managed and owned by the consumer account 350) including usage on secrets, usage on the API Integration, usage on the warehouse, and privileges granted to the instance of application 426 if it needs to access objects of the consumer account 350 or execute procedures in the consumer account 350. Once installed, the instance of application 426 may perform various functions in the consumer account 350 as long as the consumer account 350 has authorized it. The instance of application 426 can act as an agent, and take any action that any role on the consumer account 350 could take such as e.g., set up a task pipeline, set up data ingestion (e.g., via Snowpipe™ ingestion), or any other defined functionality of the application 426. The instance of application 426 may act on behalf of the consumer account 350 and execute procedures in a programmatic way.

As shown in FIG. 4A, the application package 410 is used by the provider account 310 to create a database application that can be provided to the consumer account 350. Once properly instantiated, the application 426 can be executed by the consumer account 350 and access content off the application package 410 that is shared to application instance 426 including one or more objects, such as objects 440, in a secure manner.

The application package 410 comprises one or more application artifacts 436 in the form of executable objects such as, but not limited to script files 428, python files 432, and jar files 431, that are stored in an application artifacts datastore such as a named filesystem scoped to the artifact schema 321 associated with the provider account 310. In some examples, the datastore for the application artifacts 436 includes directory data 456 accessed by the consumer application instance 426 at run time in the consumer account 454 for storage of the executable files once the application instance 426 has been instantiated. In some examples, the application artifacts 436 are defined in the artifact schema 321. In some examples, the artifact schema 321 contains script files 428 that are executed within the application instance 426 to define the application. In some examples, an application may have none or more application package versions that are containers for the artifact schema 321 and the named storage location 434.

The application package 410 further comprises shared content 438 comprising one or more data objects, such as objects 440, that constitute objects shared to the application instance 426 that are accessed and/or operated on by the application instance 426 during execution of executable objects of the versioned schema 464 of the application instance 426 such as, but not limited to, functions 418 and procedures 420. In some examples, the application package 410 includes shared content comprising one or more schemas containing objects such as, but not limited to, tables, views, and the like. In some examples, the shared content 438 is accessed by the application instance 426 based on a set of security protocols.

The application instance 426 comprises a set of versioned objects 424 that are created during the instantiation of the application instance 426. The versioned objects 424 include objects 416 of a versioned schema 464 that are defined by the application artifacts 436. In some examples, the objects 416 comprise one or more functions 418, one or more procedures 420, one or more tables 422, and the like.

In some examples, when the application instance 426 is being upgraded to a new version, the setup script modifies existing objects of the application instance 426. In some examples, the application artifacts 436 are stored as part of the version definition of the application package 410, and are stored as e.g., java jars, python files, and the like but are not installed within the application instance 426. The application artifacts 436 are referred to from objects 416 that are installed by the installation script. For example, an object of objects 416 may be a java stored procedure that refers to a jar file that is located in the versioned schema 464, but these objects are directly accessed, at run time, in the provider package when the procedure is executed.

In some examples, when a version of the application package 410 is created, the provider account 310 specifies a location of the root directory in a named storage location for that application version, and a manifest file 470 is provided in that location. The native applications framework 475 configures one or more components of the application instance 426 based on the manifest file 470. The manifest file 470 includes properties related to the application version of the application package 410 such as a name, an application version value, a display name and the like. The manifest file 470 also includes information about runtime behavior of the application instance 426 such as, but not limited to, execution of extension code, connections to external services and the Uniform Resource Locations (URLs) of those services, running of background tasks and the like. It should be noted that although the provider account 310 and the consumer account 350 are illustrated as being located on the same deployment, this is not a requirement and the embodiments of the present disclosure may be implemented when the provider account 310 and the consumer account 350 are located in different deployments.

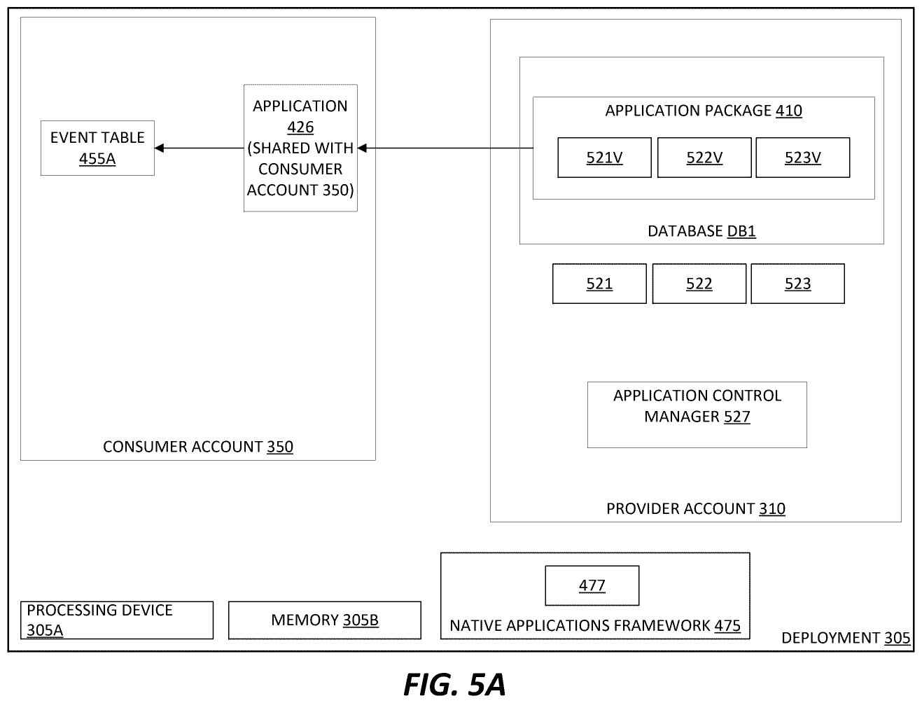

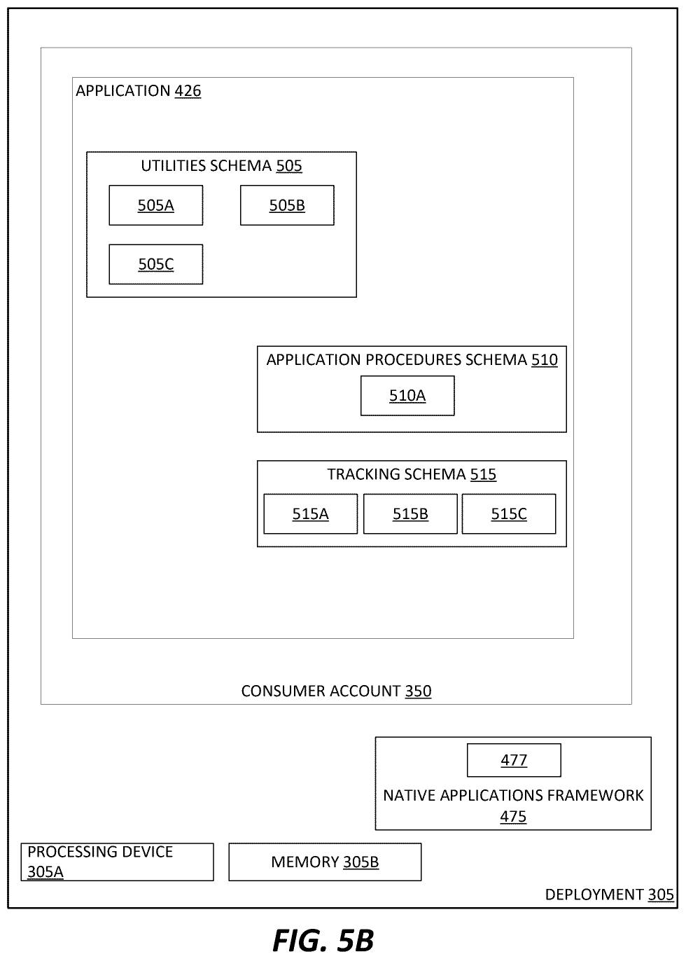

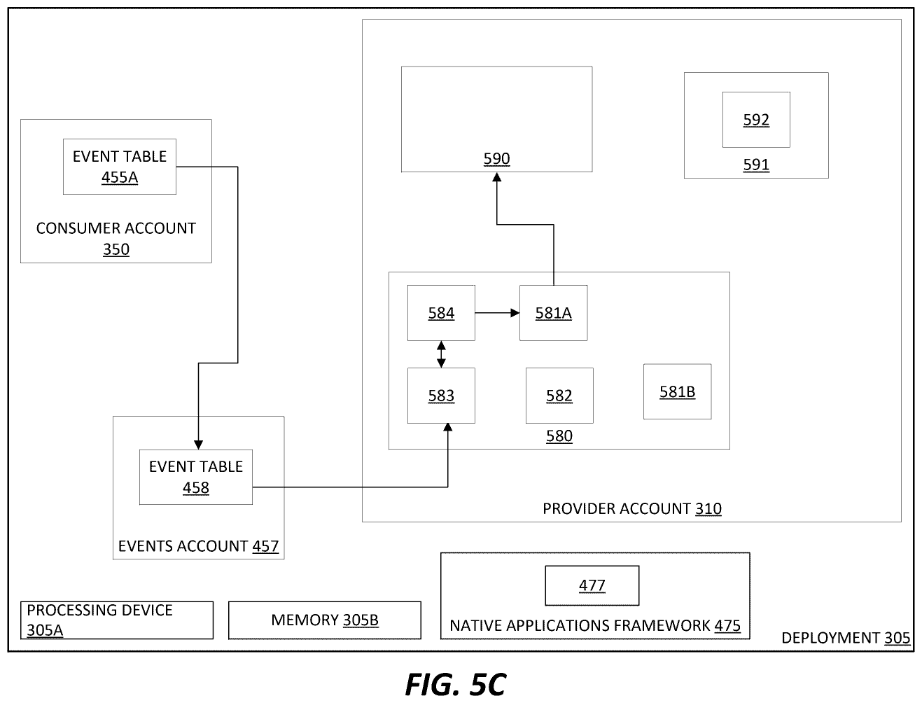

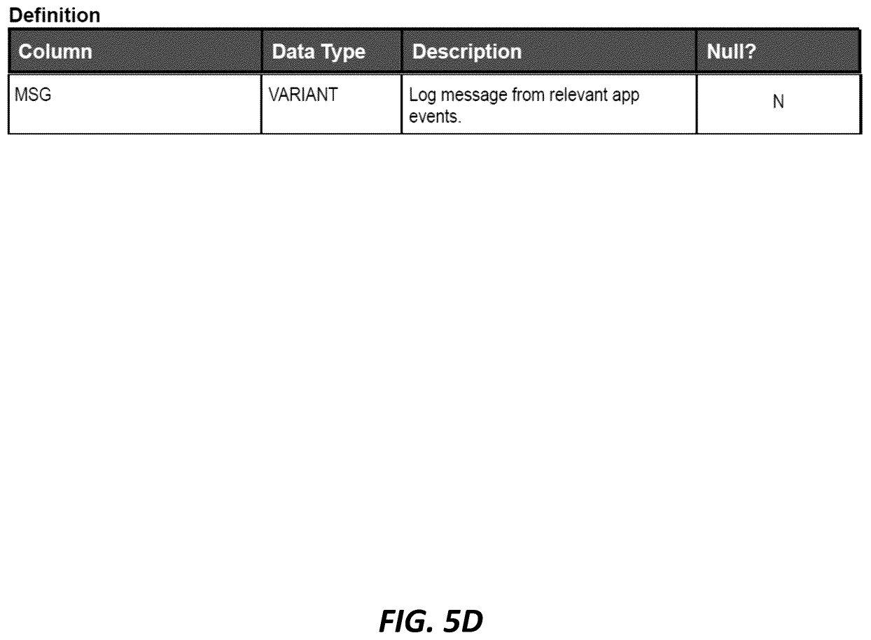

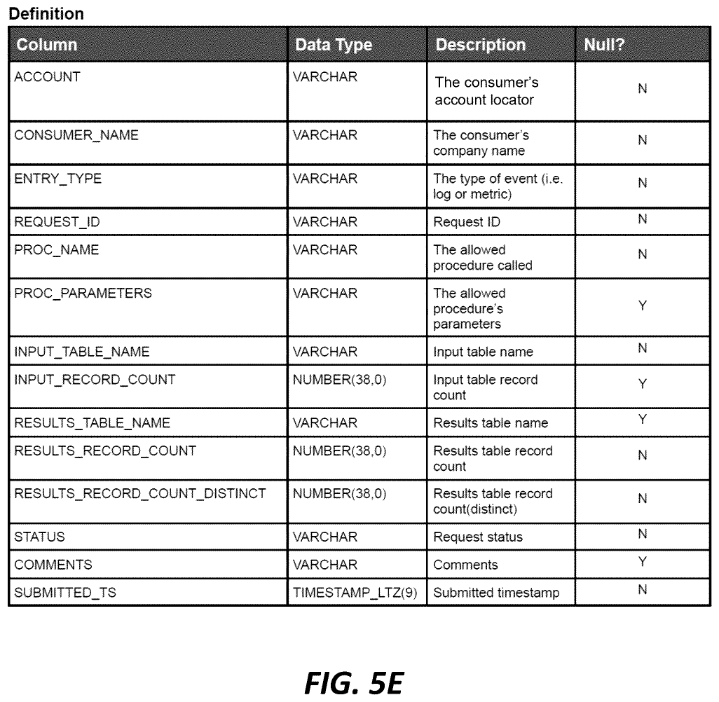

Embodiments of the present disclosure provide an application control framework 477 (hereinafter referred to as “ACF 477”), which may be a component of the native applications framework 475 (or a stand-alone software module) that allows the provider account 310 to easily build, share and manage applications via the data exchange. The ACF 477 may comprise a set of scripts that are executed to facilitate the building, sharing and managing of applications via the data exchange, as described in further detail herein. The ACF 477 may include pre-defined controls which allow the provider to manage access to and control usage of the application 426 on a per consumer or any other appropriate basis. The ACF 477 may also allow the provider to define their own custom controls to manage access to and control usage of the application 426. Once the ACF 477 scripts have been executed, the ACF 477 may generate an application control manager 527 (shown in FIG. 5A) in the provider account 310, via which the provider can easily share an application built on the ACF 477, manage use of the application on a per consumer basis, and remove the ACF 477 if/when desired as discussed in further detail herein.

The ACF 477 enables a provider to build the application 426 in a manner where each version of the application 426 may have different levels of access and usage such as different access rights/permissions (e.g., for stored procedures), different event/metric sharing requirements and different execution/record processing limits. For example, a first version of the application 426 may be a “free” version that the consumer can evaluate, without interaction from the provider. The free version may only allow access to a limited subset of the application 426's stored procedures and may only allow a relatively small number of stored procedure executions and a relatively small number of record processes. Other versions of the application 426 may be “paid” versions that have varying levels of stored procedure access and execution/record processing limits. Once the consumer is interested in one or more paid versions of the application 426, they can be granted access to the desired version via the ACF 477. Still other versions of the application 426 may allow unique entitlements/limits to be set for each consumer. The entitlements/limits are managed via the application control manager 527. This is ideal for providers that want to create custom deals with consumers where the default entitlements/limits of the other app versions are not ideal for the consumer. In some embodiments, every version of the application 426 may be offered via its own dedicated listing on the data exchange.

Referring now to FIG. 5A, the provider may provide the application logic including artifacts 436, shared content 438 and manifest file 470 to the application control manager 527, which may build the application package 410 as discussed in further detail herein. The provider may also provide to the application control manager 527 an application key, as well as limit tracking and run (execution) tracking functionality defined as part of the application logic. The application control manager 527 may include the application key and limit/run tracking functionality in the application package 410 as well. It should be noted that FIGS. 5A-5E illustrate the process of using the ACF 477 to build, share and manage a single version of application 426 via the data exchange. However, this is not a limitation and as discussed herein, the ACF 477 can be used to build, share and manage multiple versions of the application 426, each with their own levels of access and usage.

The ACF 477 may provide a number of predefined controls which the provider can define values for in order to manage (i.e., provide limits/restrictions on) access to and usage of the application 426. Each predefined control may be thought of as a rule that the provider may define values for. Examples of such predefined controls include:
A list of stored procedures of the application 426 that the provider will allow the consumer to access A list of functions of the application 426 that the provider will allow the consumer to access (
A per-record cost for using the application 426.
A limit (e.g., on the number of records that can be processed or the number of stored procedures/functions that can be executed).
The type of limit (either a limit on the number of records that can be processed or the number of stored procedures/functions that can be executed).
The interval at which the limit is enforced (e.g., 1 day).
The types of events/metrics generated by the application 426 that must be shared.
Limits on event/metric sharing. Examples include restrictions on installation events, key events performed during a request (e.g., request start, completion of a first phase of the request, completion of a second phase of the request) and the number of records and categorization of record types returned to the consumer that can be used for custom billing purposes.

Another example list of predefined controls is shown in FIG. 4B. The ACF 477 may also allow the provider to create custom controls. Custom controls can be modifications of predefined controls or entirely new controls. Custom controls may enable the provider to generate custom rules (or modifications to predefined rules) as well as values for each custom rule, and enable the provider to have even more control over access to and usage of the application 426 beyond what is offered by the predefined controls. Once the provider has defined values for the predefined controls they wish to implement and defined any custom controls (and corresponding values) they wish to implement (for this particular version of the application 426), the ACF 477 may add this information as metadata to an object within the application package 410 as discussed in further detail herein. In addition, the ACF 477 may include the predefined and custom controls in the metadata of the listing for the particular version of the application 426.

The ACF 477 may create a metadata table 521 to store metadata regarding each consumer who is to be onboarded for use of the application 426. Examples of such metadata include the consumer's data exchange account locator, the consumer's company name, the metadata key name (e.g., ‘enabled’), and blank values for each predefined and custom control. The ACF 477 may also create a controls metadata table 522 containing the definitions and key attributes (such as default value) for each pre-defined and custom control. FIG. 4C illustrates example definitions in the controls metadata table 522 for the pre-built and custom controls. The ACF 477 may also create a rules table 523 to which it may add the custom rules defined for each custom control (e.g., in JSON format) that the provider creates to further control access to the application 426. FIG. 4D illustrates an example template for entries in the rules table 523 for custom rules defined by the provider. The ACF 477 may include a view of each table 521, 522 and 523 (shown as 521V, 522V and 523V respectively in FIG. 5A) within the application package 410. The ACF 477 may also include within the application package 410, set up scripts (not shown) to facilitate installation of the application 426 as discussed in further detail herein.

The provider may list the application package 410 as either a private listing or as a public listing in the data exchange. If the application package 410 is listed as a private listing, the provider may add the consumer account 350 to the private listing. Once the consumer account 350 is interested in the application 426, they may import the application package 410, and the ACF 477 may execute the set-up script included in the application package 410 to install an instance of the application 426 in the consumer account 350 as discussed in further detail with respect to FIG. 5B. The ACF 477 may include a set of helper scripts (not shown) which it may execute upon installation of the application 426 to facilitate usage and monitoring of the instance of application 426. More specifically, the set of helper scripts may create objects that streamline usage of the application 426 (e.g., a dedicated application role, a warehouse, and helper stored procedures), create an events table 455A (if one is not already present) and insert installation logs in the events table 455A (e.g., via a stored procedure of the application 426 for inserting installation logs in an events table). It should be noted that with respect to FIGS. 5B-5E, the phrase “application 426” refers to an instance of the application 426 that is installed in the consumer account 350.

The provider may then call an onboarding procedure (not shown) of the ACF 477 which may overwrite the blank values for each predefined and custom control for the consumer in the metadata table 521 with the defined values for each predefined and custom control specified by the provider. This onboarding procedure is executed once per consumer to be onboarded. The ACF 477 may complete the installation process of the application 426 as shown in FIG. 5B.

FIG. 5B illustrates the application 426 once it is installed in the consumer account 350 (e.g., using the set-up scripts stored in the application package 410). During installation, the ACF 477 may create a utilities schema 505 containing utility-type objects such as the consumer's metadata view 505A which indicates the predefined and custom controls provided by the provider account 310 (i.e., the limitations/restrictions on the functionality and features of the application 426). The utilities schema 505 may also include a procedures table 505B that contains a list of all of the stored procedures created by the application 426, and an accessible procedures table 505C that indicates the stored procedure(s) the consumer has access to as well as the parameters passed to the accessible procedures. The ACF 477 may create the consumer's metadata view 505A, procedures table 505B and accessible procedures table 505C based on the views 521V, 522V and 523V included in the application package 410.

During installation of the application 426, the ACF 477 may also include an application procedures schema 510 that contains the request stored procedure 510A. The request stored procedure 510A may be a procedure that allows the consumer to make a request to use an allowed stored procedure listed in the accessible procedures table 505C. The request stored procedure 510A validates that the consumer can use the application 426, ensures that the consumer is allowed to call a particular requested stored procedure and/or call it with the specified parameters, and collects pre-set metrics about the request (e.g., input table record count, result record counts, etc.).

The ACF 477 may also generate within the application 426, a tracking schema 515 that contains an application key table 515A that stores the application key given by the provider to the application control manager 527 when building the application package 410. The application key is used to confirm that requests are coming from a valid installation. The tracking schema 515 may also include a limit tracking module 515B that tracks the number of records processed throughout the entire time span of the consumer's usage of the application 426, as well as the number of records processed during the current interval. The limit tracking module 515B may also track the number of record matches throughout the entire time span of the consumer's usage of the native app and the number of matches during the current interval. The tracking schema 515 may further include a run tracking module 515C that tracks each execution of each stored procedure of the application 426. The run tracking module 515C allows for local tracking of stored procedure executions in real time or near real time, since it is local and does not need to wait for the provider to send any confirmation that a run was executed etc. Similarly, the limit tracking module 515B allows for local tracking of record processes and record matches in real time or near real time. The tracking schema 515 may be non-versioned to avoid updating these objects (515A, 515B and 515C) in the event of an upgrade to the application 426. The limit tracking module 515B and the run tracking module 515C may be created based on the limit tracking and run (execution) tracking functionality respectively that were defined by the provider as part of the application logic that is provided to the application control manager 527.

In response to the consumer calling a stored procedure, the request stored procedure 510A may check the metadata view 505A and the accessible procedures table 505C, to make sure the consumer is allowed to call that procedure and/or call that procedure with the parameters specified by the consumer. The request stored procedure 510A may also compare information in the limit tracking module 515B and the run tracking module 515C to the metadata view 505A to ensure that the consumer has not reached their execution, record processing or record matching limits on a stored procedure they are trying to call. If the consumer has already reached their execution, record processing or record matching limits, the application control manager 527 may deny their request to call the stored procedure.

Referring to FIG. 5C, as the application 426 executes, it may generate events such as logs, metrics, spans, and span events. It should be noted that this list is not exhaustive and is for example purposes only, and many other event types are within the scope of the embodiments disclosed herein. These events may be stored by the ACF 477 in the event table 455A. The event table 455A may include a row for each event, a first column to indicate a type of each event (e.g., log, metric, span, or span event) and a second column to provide information regarding each event. The information regarding each event may not be stored exclusively in the second column, and the event table may include any appropriate number of columns over which the information regarding each event may be stored. When the first column for an event indicates a log event type, the corresponding entry in the second column may include e.g., severity text indicating information about the log event such as the severity of the log event. Example severity text may include Trace, Debug, Info, Warning, Error, and Fatal. Based on the severity text, a log event may be classified as e.g., a usage log, a debug log or a query audit log. In addition, the severity text may indicate a scope of the log event such as a class name for the log event. When the event type is span or span event, the second column may include e.g., a name of the span or span event. It should be noted that a span may represent an individual execution of a function or stored procedure of the application 426 while a span event may be an event record attached to a particular span execution (e.g., a record match).

In some embodiments, the events generated by the application 426 and shared to the event table 455A may then be shared by the ACF 477 to a region-specific provider events account 457 (hereinafter referred to as events account 457). The ACF 477 may filter the events shared based on any relevant event/metric sharing controls as indicated by the metadata view 505A. In some embodiments, the ACF 477 may automatically create the events account 457, which may function as a central location where a provider may store the events shared by the consumer (as well as any other consumers) in a particular region. The provider can designate an events account for each region, and shared events from each region can be directly ingested into each region's corresponding events account without traveling to a different region. This helps reduce the operational burden of the provider as they don't need to figure out which accounts have shared events for each different consumer. The provider only needs to login to the events account 457 which is in the same region as a particular consumer and can query all shared events from different applications that are being used in that region (whether by the particular consumer or other consumers). The events account 457 may include an event table 458 to store the events generated by the application 426.

The ACF 477 may create in the provider account 310 an events processing schema 580, which may include an event master table 581A to which events from the events account 457 (and any other relevant events accounts of the provider) are streamed and a control events table 581B which may include various application control framework events (e.g., onboarding/updating consumers). More specifically, the events processing schema 580 may also include an events stream object 583 that tracks changes to the event table 458. More specifically, the events stream object 583 stores an offset that is located between two versions of the event table 458. Querying the events stream object 583 returns the changes (e.g., new events) caused by transactions committed after the offset and at or before the current time. The events processing schema 580 may also include an events task 584 that queries the events stream object 583 and adds new events from the events stream object 583 to the event master table 581A.

The events processing schema 580 may also include a stored procedure 582 to analyze events that are added to the event master table 581A and check for consumer installations, requests, when to update the consumer account 350's entry in the metadata table 521 (e.g., reset interval counts, etc.). For example, with each install of the application 426, an application key is generated. When the application key is generated, an event is logged with the application key included. Once this event is processed via the ACF 477, the event is registered as a consumer install and the application key is assigned to the consumer. In another example, requests are made to use a stored procedure(s) granted to the consumer. Each request may generate an event that tracks which stored procedure is requested by the consumer and the parameters passed as part of the request. In a further example, the ACF may check for a heartbeat task (event) that keeps the streams/tasks alive, in the provider account 310, to process events from the application 426 shared with the consumer. Still further, custom billing events can be initiated and logged if the consumer is configured to be charged at a custom rate (defined in the ACF 477 metadata). For example, the stored procedure 582 may update the consumer account 350's entry in the metadata table 521 to indicate e.g., an updated number of records that have been processed or an updated number of times the consumer account 350 has executed stored procedures.

Based on the event master table 581A, the ACF 477 may create a secure view 590 that contains the event messages corresponding to the events generated by execution of the application 426 by the consumer account 350 that are added to the event master table 581A as shown in FIG. 5D. An event message refers to an event that has been received and processed from the consumer account 350. The secure view allows the provider to access the processed logs, in case any custom controls depend on receiving a particular message.

The ACF 477 may also create in the provider account 310, an events recording schema 591 including an events summary view 592 indicating all events entries (regardless of what consumer account they originate from) from the event master table 581A in tabular format as shown in FIG. 5E.

As can be seen, embodiments of the present disclosure provide an ACF 477 that allows a provider to build, share and manage native applications in a streamlined manner. The provider may simply plug their application logic, control definitions/values and source data into the ACF 477, which may handle the installation, tracking and management of the application for any of a number of consumers with limited involvement from the provider.

Embodiments of the present disclosure allow a provider to understand consumer usage of their applications, control/customize the application functionality for each consumer their application has been shared with, and disable usage of a shared application for any given reason. The disclosed embodiments are industry/vertical agnostic and enable a consumer to securely share their data with the provider's native application, leveraging native applications permissions. The provider never sees/accesses the consumer's data and the provider's data is hidden from the consumer and only shared with the application. In addition, each party's data does not need to be extracted and transferred and can remain in the respective party's account. Embodiments of the present disclosure allow a provider to either integrate existing application logic and data or deploy the ACF 477 first, and then build the application logic. The provider can also provide customizable access to each consumer of their native application and provide multiple versions of their application in a data sharing platform, each with unique features, all while using a single source for application logic and data.

FIG. 6 is a flow diagram of a method 600 for using an application control framework to build, share and manage applications via a data sharing platform, in accordance with some embodiments of the present disclosure. Method 600 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 600 may be performed by a processing device 305A of cloud deployment 305 (illustrated in FIGS. 4A and 5A).

Referring also to FIGS. 5A-5E, at block 605 the provider may provide the application logic including artifacts 436, shared content 438 and manifest file 470 to the application control manager 527, which at block 610 may build the application package 410 as discussed in further detail herein. The provider may also provide to the application control manager 527 an application key, as well as limit tracking and run (execution) tracking functionality defined as part of the application logic. The application control manager 527 may include the application key and limit/run tracking functionality in the application package 410 as well. It should be noted that FIGS. 5A-5E illustrate the process of using the ACF 477 to build, share and manage a single version of application 426 via the data exchange. However, this is not a limitation and as discussed herein, the ACF 477 can be used to build, share and manage multiple versions of the application 426, each with their own levels of access and usage.

The ACF 477 may provide a number of predefined controls which the provider can define values for in order to manage (i.e., provide limits/restrictions on) access to and usage of the application 426. Each predefined control may be thought of as a rule that the provider may define values for. Examples of such predefined controls include:

A list of stored procedures of the application 426 that the provider will allow the consumer to access A list of functions of the application 426 that the provider will allow the consumer to access.

A per-record cost for using the application 426.

A limit (e.g., on the number of records that can be processed or the number of stored procedures/functions that can be executed).

The type of limit (either a limit on the number of records that can be processed or the number of stored procedures/functions that can be executed).

The interval at which the limit is enforced (e.g., 1 day).

The types of events/metrics generated by the application 426 that must be shared.

Another example list of predefined controls is shown in FIG. 4B. The ACF 477 may also allow the provider to create custom controls. Custom controls can be modifications of predefined controls or entirely new controls. Custom controls may enable the provider to generate custom rules (or modifications to predefined rules) as well as values for each custom rule, and enable the provider to have even more control over access to and usage of the application 426 beyond what is offered by the predefined controls. Once the provider has defined values for the predefined controls they wish to implement and defined any custom controls (and corresponding values) they wish to implement (for this particular version of the application 426), the ACF 477 may add this information as metadata to an object within the application package 410 as discussed in further detail herein. In addition, the ACF 477 may include the predefined and custom controls in the metadata of the listing for the particular version of the application 426.

The ACF 477 may create a metadata table 521 to store metadata regarding each consumer who is to be onboarded for use of the application 426. Examples of such metadata include the consumer's data exchange account locator, the consumer's company name, the metadata key name (e.g., ‘enabled’), and blank values for each predefined and custom control. The ACF 477 may also create a controls metadata table 522 containing the definitions and key attributes (such as default value) for each pre-defined and custom control. FIG. 4C illustrates example definitions in the controls metadata table 522 for the pre-built and custom controls. The ACF 477 may also create a rules table 523 to which it may add the custom rules defined for each custom control (e.g., in JSON format) that the provider creates to further control access to the application 426. FIG. 4D illustrates an example template for entries in the rules table 523 for custom rules defined by the provider. The ACF 477 may include a view of each table 521, 522 and 523 (shown as 521V, 522V and 523V respectively in FIG. 5A) within the application package 410. The ACF 477 may also include within the application package 410, set up scripts (not shown) to facilitate installation of the application 426 as discussed in further detail herein.

The provider may list the application package 410 as either a private listing or as a public listing in the data exchange. If the application package 410 is listed as a private listing, the provider may add the consumer account 350 to the private listing. Once the consumer account 350 is interested in the application 426, they may import the application package 410 and at block 615, the ACF 477 may execute the set-up script included in the application package 410 to install the application 426 in the consumer account 350 as discussed in further detail with respect to FIG. 5B. The ACF 477 may include a set of helper scripts (not shown) which it may execute upon installation of the application 426 to facilitate usage and monitoring of the application. More specifically, the set of helper scripts may create objects that streamline usage of the application 426 (e.g., a dedicated application role, a warehouse, and helper stored procedures), create an events table 455A (if one is not already present) and insert installation logs in the events table 455A (e.g., via a stored procedure of the application 426 for inserting installation logs in an events table).

The provider may then call an onboarding procedure (not shown) of the ACF 477 which may overwrite the blank values for each predefined and custom control for the consumer in the metadata table 521 with the defined values for each predefined and custom control specified by the provider. This onboarding procedure is executed once per consumer to be onboarded. The ACF 477 may complete the installation process of the application 426 as shown in FIG. 5B.

FIG. 5B illustrates the application 426 once it is installed in the consumer account 350 (e.g., using the set-up scripts stored in the application package 410). During installation, the ACF 477 may create a utilities schema 505 containing utility-type objects such as the consumer's metadata view 505A which indicates the limitations/restrictions on the functionality and features of the application 426. The utilities schema 505 may also include a procedures table 505B that contains a list of all of the stored procedures created by the application 426, and an accessible procedures table 505C that indicates the stored procedure(s) the consumer has access to as well as the parameters passed to the accessible procedures. The ACF 477 may create the consumer's metadata view 505A, procedures table 505B and accessible procedures table 505C based on the views 521V, 522V and 523V included in the application package 410.

During installation of the application 426, the ACF 477 may also include an application procedures schema 510 that contains the request stored procedure 510A. The request stored procedure 510A may be a procedure that allows the consumer to make a request to use an allowed stored procedure listed in the accessible procedures table 505C. The request stored procedure 510A validates that the consumer can use the application 426, ensures that the consumer is allowed to call a particular requested stored procedure and/or call it with the specified parameters, and collects pre-set metrics about the request (e.g., input table record count, result record counts, etc.).

The ACF 477 may also generate within the application 426, a tracking schema 515 that contains an application key table 515A that stores the application key given by the provider to the application control manager 527 when building the application package 410. The application key is used to confirm that requests are coming from a valid installation. The tracking schema 515 may also include a limit tracking module 515B that tracks the number of records processed throughout the entire time span of the consumer's usage of the application 426, as well as the number of records processed during the current interval. The limit tracking module 515B may also track the number of record matches throughout the entire time span of the consumer's usage of the native app and the number of matches during the current interval. The tracking schema 515 may further include a run tracking module 515C that tracks each execution of each stored procedure of the application 426. The run tracking module 515C allows for local tracking of stored procedure executions in real time or near real time, since it is local and does not need to wait for the provider to send any confirmation that a run was executed etc. Similarly, the limit tracking module 515B allows for local tracking of record processes and record matches in real time or near real time. The tracking schema 515 may be non-versioned to avoid updating these objects (515A, 515B and 515C) in the event of an upgrade to the application 426. The limit tracking module 515B and the run tracking module 515C may be created based on the limit tracking and run (execution) tracking functionality respectively that were defined by the provider as part of the application logic that is provided to the application control manager 527.

At block 620, the ACF 477 may manage the consumer's access and use of the application 426 using the predefined and custom controls. For example, in response to the consumer calling a stored procedure, the request stored procedure 510A may check the metadata view 505A and the accessible procedures table 505C, to make sure the consumer is allowed to call that procedure and/or call that procedure with the parameters specified by the consumer. The request stored procedure 510A may also compare information in the limit tracking module 515B and the run tracking module 515C to the metadata view 505A to ensure that the consumer has not reached their execution, record processing or record matching limits on a stored procedure they are trying to call. If the consumer has already reached their execution, record processing or record matching limits, the application control manager 527 may deny their request to call the stored procedure.

Referring to FIG. 5C, as the application 426 executes, it may generate events such as logs, metrics, spans, and span events. It should be noted that this list is not exhaustive and is for example purposes only, and many other event types are within the scope of the embodiments disclosed herein. These events may be stored by the ACF 477 in the event table 455A. The event table 455A may include a row for each event, a first column to indicate a type of each event (e.g., log, metric, span, or span event) and a second column to provide information regarding each event. The information regarding each event may not be stored exclusively in the second column, and the event table may include any appropriate number of columns over which the information regarding each event may be stored. When the first column for an event indicates a log event type, the corresponding entry in the second column may include e.g., severity text indicating information about the log event such as the severity of the log event. Example severity text may include Trace, Debug, Info, Warning, Error, and Fatal. Based on the severity text, a log event may be classified as e.g., a usage log, a debug log or a query audit log. In addition, the severity text may indicate a scope of the log event such as a class name for the log event. When the event type is span or span event, the second column may include e.g., a name of the span or span event. It should be noted that a span may represent an individual execution of a function or stored procedure of the application 426 while a span event may be an event record attached to a particular span execution (e.g., a record match).

In some embodiments, the events generated by the application 426 and shared to the event table 455A may then be shared by the ACF 477 to a region-specific provider events account 457 (hereinafter referred to as events account 457). The ACF 477 may filter the events shared based on any relevant event/metric sharing controls as indicated by the metadata view 505A. In some embodiments, the ACF 477 may automatically create the events account 457, which may function as a central location where a provider may store the events shared by the consumer (as well as any other consumers) in a particular region. The provider can designate an events account for each region, and shared events from each region can be directly ingested into each region's corresponding events account without traveling to a different region. This helps reduce the operational burden of the provider as they don't need to figure out which accounts have shared events for each different consumer. The provider only needs to login to the events account 457 which is in the same region as the consumer and can query all shared events from different applications that are being used in that region. The events account 457 may include an event table 458 to store the events generated by the application 426.

The ACF 477 may create in the provider account 310 an events processing schema 580, which may include an event master table 581A to which events from the events account 457 (and any other relevant events accounts of the provider) are streamed and a control events table 581B which may include various application control framework events (e.g., onboarding/updating consumers). More specifically, the events processing schema 580 may also include an events stream object 583 that tracks changes to the event table 458. More specifically, the events stream object 583 stores an offset that is located between two versions of the event table 458. Querying the events stream object 583 returns the changes (e.g., new events) caused by transactions committed after the offset and at or before the current time. The events processing schema 580 may also include an events task 584 that queries the events stream object 583 and adds new events from the events stream object 583 to the event master table 581A.

The events processing schema 580 may also include a stored procedure 582 to analyze events that are added to the event master table 581A and check for consumer installations, requests, when to update the consumer account 350's entry in the metadata table 521 (e.g., reset interval counts, etc.). For example, the stored procedure 582 may update the consumer account 350's entry in the metadata table 521 to indicate e.g., an updated number of records that have been processed or an updated number of times the consumer account 350 has executed stored procedures.

Based on the event master table 581A, the ACF 477 may create a secure view 590 that contains the event messages corresponding to the events generated by execution of the application 426 by the consumer account 350 that are added to the event master table 581A as shown in FIG. 5D. The ACF 477 may also create in the provider account 310, an events recording schema 591 including an events summary view 592 indicating all events entries (regardless of what consumer account they originate from) from the event master table 581A in tabular format as shown in FIG. 5E.

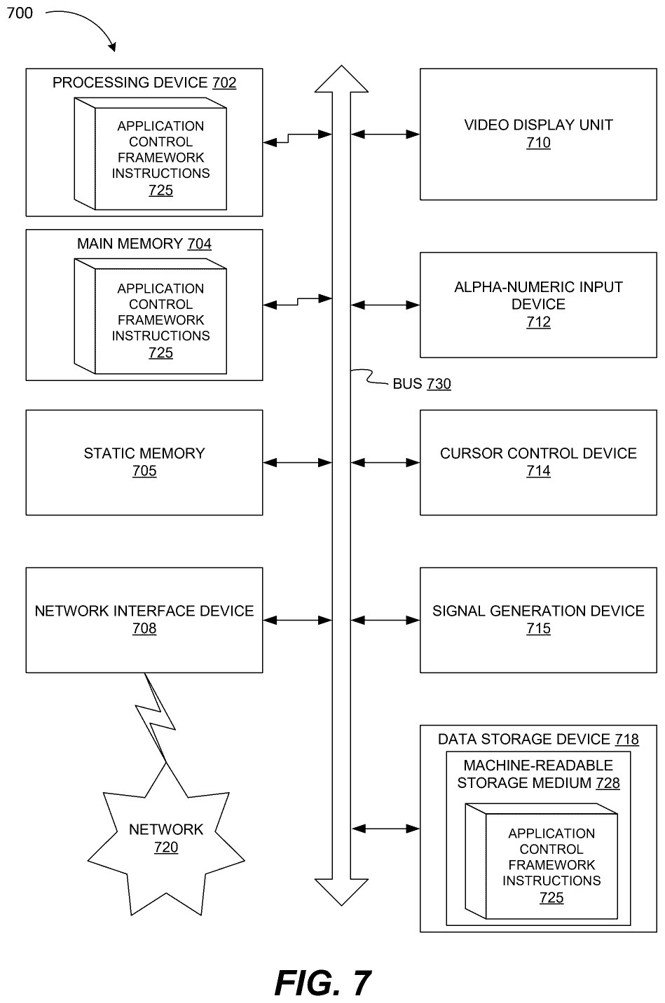

FIG. 7 illustrates a diagrammatic representation of a machine in the example form of a computer system 700 within which a set of instructions is included, the instructions to cause the machine to perform any of the methodologies discussed herein for selectively sharing with a provider account of a data exchange, events generated by an application shared by the provider account via the data exchange.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 700 may be representative of a server.

The exemplary computer system 700 includes a processing device 702, a main memory 704 (e.g., read-only memory (ROM), flash memory, dynamic random access memory (DRAM), a static memory 705 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 700 may further include a network interface device 708 which may communicate with a network 720. The computing device 700 also may include a video display unit 710 (e.g., a liquid crystal display (LCD) or a cathode ray tube (CRT)), an alpha-numeric input device 712 (e.g., a keyboard), a cursor control device 714 (e.g., a mouse) and an acoustic signal generation device 715 (e.g., a speaker). In one embodiment, video display unit 710, alphanumeric input device 712, and cursor control device 714 may be combined into a single component or device (e.g., an LCD touch screen).

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute access control framework instructions 725, for performing the operations and steps discussed herein.

The data storage device 718 may include a machine-readable storage medium 728, on which is stored one or more sets of access control framework instructions 725 (e.g., software) embodying any one or more of the methodologies of functions described herein. The access control framework instructions 725 may also reside, completely or at least partially, within the main memory 704 or within the processing device 702 during execution thereof by the computer system 700; the main memory 704 and the processing device 702 also constituting machine-readable storage media. The access control framework instructions 725 may further be transmitted or received over a network 720 via the network interface device 708.

The machine-readable storage medium 728 may also be used to store instructions to perform a method for sharing events generated from a native application being shared by a provider account and executed by a consumer account, as described herein. While the machine-readable storage medium 728 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “providing,” “building,” “calling,” “managing,” “receiving,” “creating,” “installing,” “determining,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned (including via virtualization) and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams or flow diagrams, and combinations of blocks in the block diagrams or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
providing, to an application control framework, application logic corresponding to an application to be shared on a data sharing platform;
building, by the application control framework, an application package comprising an install script to install the application and a set of controls to manage access to the application;
in response to a consumer of the data sharing platform importing the application package, calling, by the application control framework, the set of install scripts to install an instance of the application in the consumer account; and
managing access to the application instance by the consumer based on the set of controls.

2. The method of claim 1, further comprising:
providing, by the application control framework, a set of predefined controls, wherein each of the set of predefined controls restricts usage of the application instance; and
receiving, from the provider account, a value for one or more of the set of predefined controls, wherein the set of controls includes each of the one or more predefined controls and the corresponding received value for each of the one or more predefined controls.

3. The method of claim 2, wherein the set of predefined controls comprises:
a list of stored procedures among a set of stored procedures of the application instance that the consumer has access to;
a limit on a number of times any of the set of stored procedures of the application instance can be executed;
a limit on a number of records that can be processed using the application instance; and
an indication of what types of metrics generated by the application instance must be shared.

4. The method of claim 2, further comprising:
receiving, from the provider account, a definition for each of a set of custom controls, wherein each of the set of custom controls restricts usage of the application instance; and
receiving, from the provider account, a value for each of the set of custom controls, wherein the set of controls further includes each of the set of custom controls and the corresponding received value for each of the set of predefined controls.

5. The method of claim 3, wherein installing the application instance in the consumer account comprises:
creating a metadata view indicating the set of controls;
creating a run tracking table locally on the application instance based on tracking functionality included by the application control framework in the application package, wherein the run tracking table tracks a number of times any of the set of stored procedures of the application instance can be executed;
creating a limit tracking table locally on the application instance based on the tracking functionality, wherein the limit tracking table tracks a number of times a record is processed by the application instance; and
installing in the application instance, a request stored procedure via which the consumer requests access to the set of stored procedures of the application instance.

6. The method of claim 5, further comprising:
in response to a request to access a stored procedure of the set of stored procedures of the application instance, determining whether to grant access to the stored procedure by:
determining whether the stored procedure is on the list of stored procedures;
using the run tracking table and the metadata view to determine whether execution of the stored procedure will violate the limit on the number of times any of the set of stored procedures of the application instance can be executed; and
using the limit tracking table and the metadata view to determine whether execution of the stored procedure will violate the limit on the number of records that can be processed using the application instance.

7. The method of claim 1, further comprising:
creating, by the application control framework, one or more objects that streamline usage of the application instance including a dedicated application role, a virtual warehouse and an event table to store metrics generated by the application instance.

8. A system comprising:
a memory; and
a processing device operatively coupled to the memory, the processing device to:
provide, to an application control framework, application logic corresponding to an application to be shared on a data sharing platform;
build, by the application control framework, an application package comprising an install script to install the application and a set of controls to manage access to the application;
in response to a consumer of the data sharing platform importing the application package, call, by the application control framework, the set of install scripts to install an instance of the application in the consumer account; and
manage access to the application instance by the consumer based on the set of controls.

9. The system of claim 8, wherein the processing device is further to:
provide, by the application control framework, a set of predefined controls, wherein each of the set of predefined controls restricts usage of the application instance; and
receive, from the provider account, a value for one or more of the set of predefined controls, wherein the set of controls includes each of the one or more predefined controls and the corresponding received value for each of the one or more predefined controls.

10. The system of claim 9, wherein the set of predefined controls comprises:
a list of stored procedures among a set of stored procedures of the application instance that the consumer has access to;
a limit on a number of times any of the set of stored procedures of the application instance can be executed;
a limit on a number of records that can be processed using the application instance; and
an indication of what types of metrics generated by the application instance must be shared.

11. The system of claim 9, wherein the processing device is further to:
receiving, from the provider account, a definition for each of a set of custom controls, wherein each of the set of custom controls restricts usage of the application instance; and
receiving, from the provider account, a value for each of the set of custom controls, wherein the set of controls further includes each of the set of custom controls and the corresponding received value for each of the set of predefined controls.

12. The system of claim 10, wherein to install the application instance in the consumer account, the processing device is to:
create a metadata view indicating the set of controls;
create a run tracking table locally on the application instance based on tracking functionality included by the application control framework in the application package, wherein the run tracking table tracks a number of times any of the set of stored procedures of the application instance can be executed;
create a limit tracking table locally on the application instance based on the tracking functionality, wherein the limit tracking table tracks a number of times a record is processed by the application instance; and
install in the application instance, a request stored procedure via which the consumer requests access to the set of stored procedures of the application instance.

13. The system of claim 12, wherein the processing device is further to:
in response to a request to access a stored procedure of the set of stored procedures of the application instance, determine whether to grant access to the stored procedure by:
determining whether the stored procedure is on the list of stored procedures;
using the run tracking table and the metadata view to determine whether execution of the stored procedure will violate the limit on the number of times any of the set of stored procedures of the application instance can be executed; and
using the limit tracking table and the metadata view to determine whether execution of the stored procedure will violate the limit on the number of records that can be processed using the application instance.

14. The system of claim 8, wherein the processing device is further to:
create, by the application control framework, one or more objects that streamline usage of the application instance including a dedicated application role, a virtual warehouse and an event table to store metrics generated by the application instance.

15. A non-transitory computer-readable medium having instructions stored thereon which, when executed by a processing device, cause the processing device to:
provide, to an application control framework, application logic corresponding to an application to be shared on a data sharing platform;
build, by the application control framework, an application package comprising an install script to install the application and a set of controls to manage access to the application;
in response to a consumer of the data sharing platform importing the application package, call, by the application control framework, the set of install scripts to install an instance of the application in the consumer account; and
manage access to the application instance by the consumer based on the set of controls.

16. The non-transitory computer-readable medium of claim 15, wherein the processing device is further to:
provide, by the application control framework, a set of predefined controls, wherein each of the set of predefined controls restricts usage of the application instance; and
receive, from the provider account, a value for one or more of the set of predefined controls, wherein the set of controls includes each of the one or more predefined controls and the corresponding received value for each of the one or more predefined controls.

17. The non-transitory computer-readable medium of claim 16, wherein the set of predefined controls comprises:
a list of stored procedures among a set of stored procedures of the application instance that the consumer has access to;
a limit on a number of times any of the set of stored procedures of the application instance can be executed;
a limit on a number of records that can be processed using the application instance; and
an indication of what types of metrics generated by the application instance must be shared.

18. The non-transitory computer-readable medium of claim 16, wherein the processing device is further to:
receiving, from the provider account, a definition for each of a set of custom controls, wherein each of the set of custom controls restricts usage of the application instance; and
receiving, from the provider account, a value for each of the set of custom controls, wherein the set of controls further includes each of the set of custom controls and the corresponding received value for each of the set of predefined controls.

19. The non-transitory computer-readable medium of claim 17, wherein to install the application instance in the consumer account, the processing device is to:
create a metadata view indicating the set of controls;
create a run tracking table locally on the application instance based on tracking functionality included by the application control framework in the application package, wherein the run tracking table tracks a number of times any of the set of stored procedures of the application instance can be executed;
create a limit tracking table locally on the application instance based on the tracking functionality, wherein the limit tracking table tracks a number of times a record is processed by the application instance; and
install in the application instance, a request stored procedure via which the consumer requests access to the set of stored procedures of the application instance.

20. The non-transitory computer-readable medium of claim 19, wherein the processing device is further to:
in response to a request to access a stored procedure of the set of stored procedures of the application instance, determine whether to grant access to the stored procedure by:
determining whether the stored procedure is on the list of stored procedures;
using the run tracking table and the metadata view to determine whether execution of the stored procedure will violate the limit on the number of times any of the set of stored procedures of the application instance can be executed; and
using the limit tracking table and the metadata view to determine whether execution of the stored procedure will violate the limit on the number of records that can be processed using the application instance.

21. The non-transitory computer-readable medium of claim 15, wherein the processing device is further to:
create, by the application control framework, one or more objects that streamline usage of the application instance including a dedicated application role, a virtual warehouse and an event table to store metrics generated by the application instance.
